(19) United States
(12) Patent Application Publication
(10) Pub. No.: US 2007/0168260 A1
(43) Pub. Date: Jul. 19, 2007

(54) Payment apparatus and method

(75) Inventors: Alexandru Cunescu, Brussels (BE); David A. Roberts, Warrington (GB); David Bibby, Brussels (BE)

Correspondence Address: Ryan, Mason & Lewis, LLP, Suite 205, 1300 Post Road, Fairfield, CT, 06284, US

(73) Assignee: MasterCard International Incorporated, Purchase, NY (US)

(21) Appl. No.: 11/526,444

(22) Filed: Sep. 25, 2006

Related U.S. Application Data
(60) Provisional application No. 60/722,190, filed on Sep. 30, 2005.

(51) Int. Cl. G06Q 30/00

(52) U.S. Cl. 705/26

(57) ABSTRACT

Techniques are provided for updating an offline parameter of a payment device having an online-capable application and a primarily offline application. The offline parameter can be a counter reflective of an offline spending balance. The same parameter can be shared between the applications, or cross-application visibility of the parameter can be provided. When a requirement to update the offline parameter is determined, the offline parameter can be updated substantially contemporaneously with an online transaction. The updates can be transparent to the user, allowing substantial duplication of the debit card and/or credit card experience with an offline payment device.

### CROSS-REFERENCE TO RELATED APPLICATIONS

This patent application claims the benefit of U.S. Provisional Patent Application Ser. No. 60/722,190 filed on Sep. 30, 2005, and entitled “Payment Apparatus and Method.” The disclosure of the aforementioned Provisional Patent Application Ser. No. 60/722,190 is expressly incorporated herein by reference in its entirety.

### FIELD OF THE INVENTION

The present invention generally relates to apparatuses and methods for financial transactions, and, more particularly, to a payment apparatus and method.

### BACKGROUND OF THE INVENTION

Cards and other devices for performing financial transactions may operate in online or offline modes. In an online mode, communication is established with a host computer of an issuer to ensure, for example, that sufficient funds are available for a transaction, that a card or other payment device has not been reported as lost or stolen, and so on. Online transactions have the advantage of potentially greater security, protecting the card holder and the merchant from loss, theft, insufficient funds, and the like. However, they may be relatively slow and/or inconvenient, and may therefore be avoided by card holders, especially for lower value transactions. In an offline mode, a transaction can proceed without establishing communication with a remote host.

U.S. Pat. No. 5,744,787 to Teicher discloses a retail unit facilitating a purchase of a customer having an electronic wallet, which includes an electronic checkbook and an electronic purse. The retail unit includes a POS which determines the purchase price, and a payment unit for receiving payment from the electronic wallet. The payment unit, upon receipt of an electronic wallet and of a purchase price from the POS, determines automatically whether to: (a) receive via the electronic checkbook a purchase price greater than or equal to a predetermined minimal checkbook payment sum; or, (b) receive the purchase price from electronic purse; or, (c) first replenish the electronic purse via electronic checkbook with at least the larger of a predetermined minimal purse replenishment sum and the difference between the purchase price and the electronic purse's stored value, and then receive the purchase price from electronic purse. Thus, it appears that in the Teicher reference, a central decision function takes place when presented for payment, namely, which payment method is to be used?

U.S. Patent Application Publication No. US 2004/0006536 of Kawashima et al. discloses an electronic money system related to network type and IC card type electronic money for preventing an affiliated store from failure to collect a purchase amount and for permitting shopping to be securely accomplished through the intermediary of a network. A user terminal accesses an affiliated store terminal through the intermediary of the Internet to purchase a commodity. The affiliated store terminal refers to a settlement apparatus through the intermediary of the Internet for the balance of electronic money stored in a database of an e-Wallet of the user of the user terminal. If the balance is larger than a purchase amount, then the settlement apparatus subtracts the purchase amount from the balance to update the balance. If the balance is smaller than the purchase amount, then an overdraft amount based on a credit level of the user is added to the balance, and if the resulting total amount is larger than the purchase, the settlement is carried out. The techniques of the Kawashima reference thus appear somewhat similar to those of the Teicher reference.

Patent Abstracts of Japan 54-149444 discloses an automatic cash payment system to make it possible to use payment processing, accompanied with online and offline, commonly by one account and one card in the automatic cash payment system. Whether the totaled deposit balance of a customer is equal to or more than the twice card limit amount and the next-period update stand-by amount can be ensured or not is stored at every prescribed period, and the card balance is updated on a basis of this storage at the first offline payment time of the next period, so that cash payment can be performed even when the card is used only for offline. Further, a center discriminates whether the stand-by amount can be ensured or not when the first transaction processing is performed in the prescribed period, and stores the result into the file of a terminal at the first offline payment time of the next period. As a result, it is unnecessary to update files simultaneously, and a time margin can be given to the processing.

U.S. Patent Application Publication No. US 2004/0230535 A1 of Binder et al. discloses a method and system for conducting off-line and on-line pre-authorized payment transactions. The method includes utilizing a card for conducting a transaction and reading from the card a pre-authorized balance, a pre-authorized limit, and an account number. The method also includes requesting on-line authorization in the event the value of the transaction is greater than the difference between the pre-authorized limit and the pre-authorized balance. Finally, the method includes receiving authorization to conduct the transaction and updating by the card the pre-authorized balance and the pre-authorized limit, wherein the card issuer, through an integrated circuit device, is able to continually update the pre-authorized limit based on various factors including the transaction and account activity.

In the techniques disclosed in the Binder et al. application, the transaction card goes online if the predetermined monetary value of the goods or services the customer wishes to purchase is greater than the difference between a monetary amount of a pre-authorized limit field and a monetary amount of a pre-authorized balance field, in other words, if the sale price is too large. The transaction card will also go online if the customer indicated that a change in the pre-authorized amount is desired.

While the techniques disclosed in the Binder et al. application represent a substantial advance in the state of the art, “topping up” the offline balance may require either a failed attempt at an offline transaction (due to a too-large sale price) or a conscious decision on the part of the card holder. The Binder et al. application thus discloses a single offline application that goes online for topping up in response to such a conscious decision or failed offline transaction attempt; if online access is unavailable in the latter case the transaction may fail completely (i.e., not be able to be completed online).

Accordingly, a need exists for a way to ensure an adequate offline balance in a manner that is more convenient for a user than the above-described prior techniques, potentially more closely replicating the experience of debit (or credit) card use but with the capability of conducting offline transactions.

### SUMMARY OF THE INVENTION

Principles of the present invention provide techniques for updating an offline parameter of a payment device, such as a card, having both an online-capable application, such as a debit and/or credit payment application, and a primarily offline application, such as an offline payment application. An exemplary embodiment of a method (which can be computer-implemented), according to one aspect of the invention, includes the steps of detecting a requirement to update the offline parameter, and then updating the offline parameter substantially contemporaneously with an online transaction. In one approach, an online transaction, such as a debit or credit card transaction, is conducted via the online-capable application. A value of the offline parameter is determined, and if an update is required, a second transaction is conducted with the primarily offline application to update the value of the offline parameter. The offline parameter can be, for example, a value reflecting the cumulative offline transaction amount, or a spending limit imposed on such amount.

In another approach, status of the primarily offline application is detected via the online-capable application; communication (e.g. with a remote host) is established via the online-capable application, and an update to the offline parameter of the primarily offline application is obtained via the online-capable application.

An exemplary embodiment of a payment apparatus (such as a card), according to another aspect of the invention, can include a body portion, a memory associated with the body portion, and at least one processor associated with the body portion and coupled to the memory. The memory can contain the aforementioned online-capable and primarily offline applications. The processor can be operative to perform one or more of the method steps described herein. The applications can be configured to share a common parameter or parameters, such as a counter or counters, or the online-capable application can be given visibility into parameters (such as counters and/or limits) of the primarily offline application (and/or the converse can be true, i.e., provision can be made for visibility of online parameters by the offline application). The primarily offline application need not necessarily be capable of going online, as parameter update (such as top up) for the primarily offline application can be accomplished via the online-capable application, with inter-application communication according to techniques of the present invention.

An exemplary embodiment of terminal apparatus for interacting with a payment apparatus of the kind described, according to still another aspect of the invention, can include a reader module, a memory associated with the reader module, and at least one processor coupled to the memory. The processor can be operative to perform one or more of the method steps described herein.

Techniques of the present invention, employing a primarily offline application and an online-capable application, can provide substantial benefits, essentially allowing one to operate with impunity at offline-only terminals (e.g., parking meters and the like). Thus, beneficial technical effects of the two-application approach of the present invention can include, for example, one or more of reducing overall transactions time since one need not await failure of an attempted offline transaction, and eliminating the need for complex installations such as communications devices in remote locations such as parking meters, vending machines, and so on. Further, one or more embodiments of the invention do not require a decision process routing to the appropriate method, rather, two separate payment applications each are used in their own right, but with communication between them.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary embodiment of a payment system according to an aspect of the present invention;

FIG. 2 presents a flow chart of an exemplary method for updating an offline parameter or parameters according to another aspect of the present invention;

FIG. 3 shows a flow chart of one possible detailed approach to updating an offline parameter or parameters;

FIG. 4 shows a flow chart of another possible detailed approach to updating an offline parameter or parameters;

FIG. 5 shows a flow chart of certain optional method steps useful in connection with the method of FIG. 2;

FIG. 6 shows a flow chart of certain other optional method steps useful in connection with the method of FIG. 2;

FIG. 7 shows one exemplary embodiment of a configuration of online-capable and primarily offline applications on a payment device, using techniques of the present invention;

FIG. 8 shows another exemplary embodiment of a configuration of online-capable and primarily offline applications on a payment device, using techniques of the present invention;

FIG. 9 shows still another exemplary embodiment of a configuration of online-capable and primarily offline applications on a payment device, using techniques of the present invention;

FIG. 10 shows yet another exemplary embodiment of a configuration of online-capable and primarily offline applications on a payment device, using techniques of the present invention; and

FIG. 11 is a system block diagram of a computer system having applicability to one or more elements of one or more embodiments of the present invention.

### DETAILED DESCRIPTION OF PREFERRED EMBODIMENTS

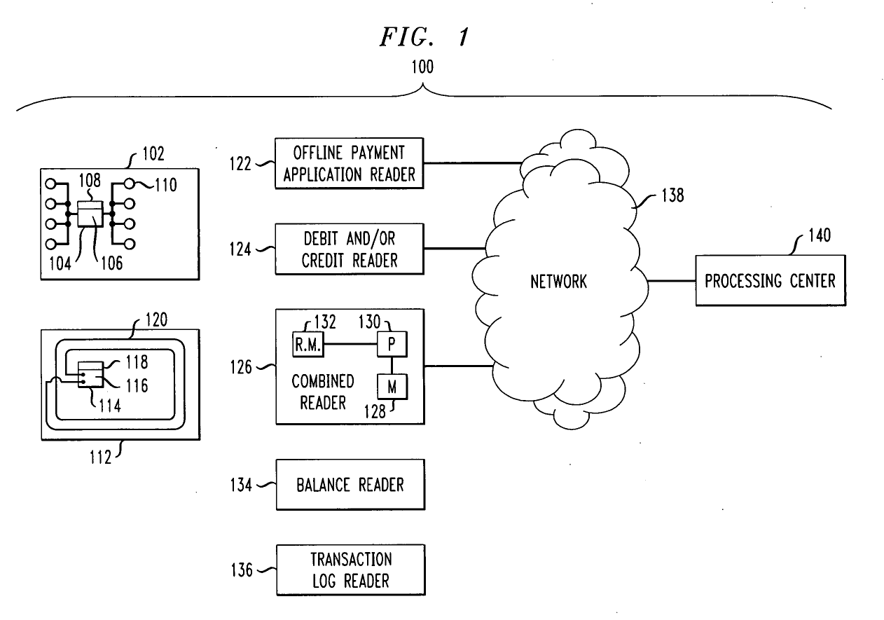

Attention should now be given to FIG. 1, which depicts an exemplary embodiment of a payment system 100, according to an aspect of the present invention, and including various possible components of the system. System 100 can be designed, for example, to work with a contact payment device such as card 102. Card 102 can include an integrated circuit (IC) chip 104 having a processor portion 106 and a memory portion 108. A plurality of electrical contacts 10 can be provided for communication purposes. In addition to or instead of card 102, system 100 can also be designed to work with a contactless payment device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of payment devices that can be employed with techniques of the present invention.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”). The memory portions or units 108, 118 can store the operating system of the cards 102, 112. The operating system loads and executes applications and provides file management or other basic card services to the applications. In some embodiments, one or more applications may “sit” directly on hardware, e.g., may be outside the domain of the operating system. One operating system that can be used to implement the present invention is the MULTOS™ operating system licensed by StepNexus Inc. Alternatively, Java Card-based operating systems, based on Java Card technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

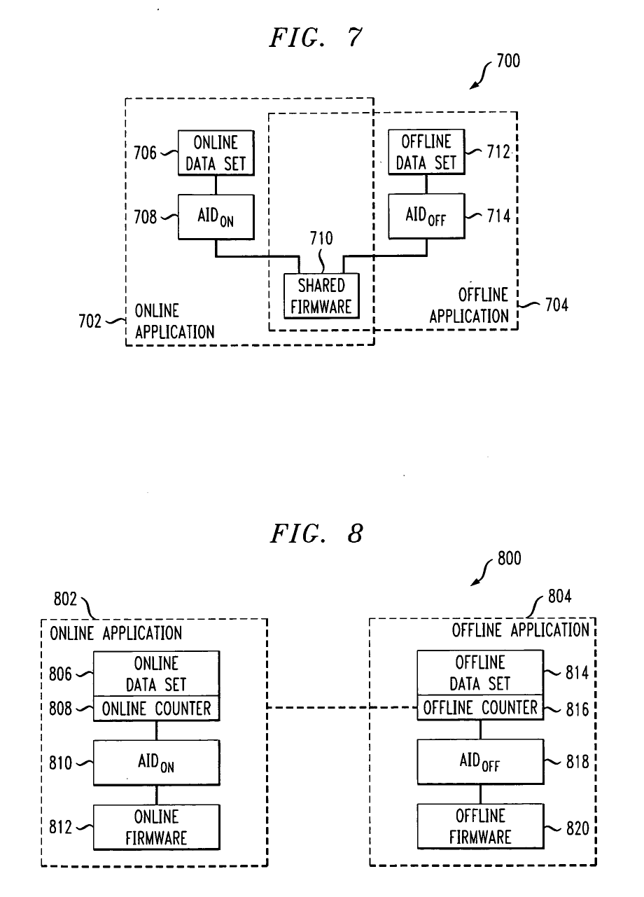

In addition to the basic services provided by the operating system, memory portions 108, 118 may also include one or more applications, for example, an online-capable application, such a as debit and/or credit payment application, and a primarily offline application, such as an offline payment application. Examples of such applications will be given in greater detail below. At present, one preferred standard to which such applications may conform is the EMV payment standard set forth by EMVCo, LLC (http://www.emvco.com). It will be appreciated that, strictly speaking, the EMV standard defines the behavior of a terminal; however, the card can be configured to conform with such EMV-compliant terminal behavior and in such a sense is itself EMV-compliant. It will also be appreciated that applications in accordance with the present invention, such as described below with respect to FIGS. 7-10, can be configured in a variety of different ways.

It will be appreciated that, as noted, cards 102, 112 are examples of a variety of payment apparatuses that can be employed with techniques of the present invention. Such devices could include cards having a conventional form factor, smaller or larger cards, cards of different shape, key fobs, personal digital assistants (PDAs), or indeed any device with the processing and memory capabilities to implement techniques of the present invention (allowing for update of at least one parameter). The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can, as noted, contain the online-capable application and the primarily offline application, which can have one or more offline parameters, as described herein. The processors 106, 116 can be operative to execute one or more method steps to be described herein. The applications can be, for example, application identifiers (AIDs) linked to software code in the form of firmware plus data in a card memory such as an electrically erasable programmable read-only memory (EEPROM). For example, one could have two applications in the sense of two AIDs pointing to the same software but with different data sets, effectively running the same code for different data. One could alternatively have two separate applications in the sense of two different instances of the same software.

System 100 can also include one or more different types of readers. Reader 122 can be configured to interact with the primarily offline application, such as the primarily offline payment application. Reader 124 can be configured to interact with the online-capable application, such as the credit and/or debit payment application. Reader 126 can be configured to interact with either type of application, and will be described in greater detail for illustrative purposes (the general principles of construction of reader 126 are applicable to other types of readers or terminals). Reader 126 can include a memory 128, a processor portion 130, and a reader module 132. Reader module 132 can be configured for contact communication with card 102, or contactless communication with card 112, or both (different types of readers can be provided to interact with different types of cards, e.g., contacted or contactless). Optionally, balance reader 134 can be provided for reading an offline balance (and displaying same to a card holder), and transaction log reader 136 can be provided, for reading a log of offline transactions, and again displaying same to a card holder. As shown with respect to readers 122, 124, and 126, connection can be provided by a computer network 138, such as the Internet, or a proprietary network, to a processing center 140 which can include a host computer of a card issuer. Readers intended solely for offline applications, such as 134 and 136, do not necessarily require a network connection (this can also be true for reader 122).

Note that cards or other payment devices for use with the present invention could employ multiple IC chips. For example, one might use a contact chip for debit applications, and a contactless chip for offline spending. Appropriate communication would have to be provided between the chips in this case. A single chip could also be configured for both contacted and contactless communications.

An exemplary embodiment of terminal apparatus for interacting with a payment apparatus of the kind described herein, can include a reader module such as 132, a memory 128 associated with the reader module 132, and at least one processor 130 coupled to the memory 128. The processor 130 can be operative to perform one or more of the method steps described herein. The terminal apparatus can be coupled to the processing center 140 via network 138. Other types of readers and/or terminals could be employed, such as automated teller machines (ATMs) modified in accordance with the principles of the present invention.

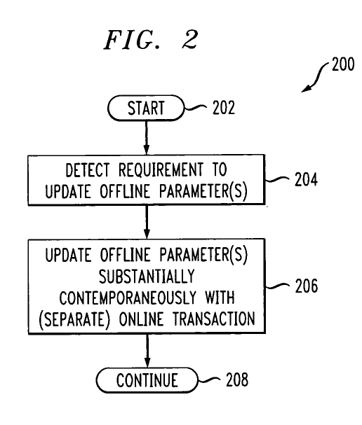

FIG. 2 shows a flow chart 200 of steps in an exemplary method, which can be computer-implemented, of updating an offline parameter of a payment device having an online-capable application and a primarily offline application. After starting at block 202, the method can include the steps of detecting, as at block 204, a requirement to update the offline parameter (or, as described below, parameters), and updating the offline parameter(s), as at block 206, substantially contemporaneously with an online transaction. As shown at block 208, after the update, one can continue with additional transactions or updates as required or desired. Reference to a “requirement” to update the offline parameter should be broadly understood to include topping up in response to a low balance (response driven by identifiable user need) or automatically topping up (as needed) whenever the card or other payment device “goes online” (requirement driven by desire to always have sufficient funds available for offline purchases). The online transaction can, in some embodiments, be separate; reference to a “separate” online transaction is intended to cover, as distinguished from the Binder et al. publication (and other references discussed in the Background of the Invention section), an online transaction for its own sake, not one manually initiated by a user for topping up purposes, or by an attempted offline purchase that fails due to a too-low offline balance. A “separate” online transaction could include, for example, topping up whenever a remaining offline balance is low or whenever a user is to go online in any case for a credit or debit transaction. Stated in another way, in prior-art references, a central decision function takes place when a device is presented for payment—which payment method is to be used? In any case the opportunity to “top up” is made. This differs from a “separate” online transaction in the sense of the invention, in that one or more inventive embodiments make no such decision; there is always the intent to pay with one or the other mode (offline or online) but the two applications internally communicate to allow top up. By way of further clarification, one or more inventive embodiments do not require some decision process routing to the appropriate method, but rather employ two separate payment applications that each are used in their own right but with communication between them. In such inventive embodiments, the communication between the applications is not just another way of deciding which application to pay with, as that decision is made externally by the terminal, and the card (or other device) does not change the decision. Rather, the communication between the applications means that an application can assist another application by helping it to get topped up. “Substantially contemporaneous” should be understood to include simultaneously, immediately preceding, immediately following, or close in time during a related stream of transactions or occurrences.

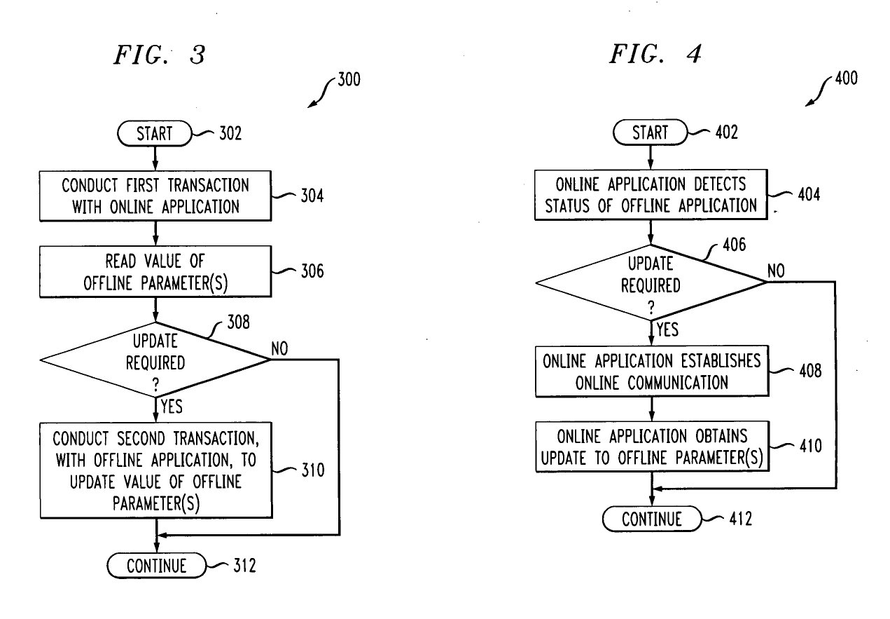

FIG. 3 shows a flow chart 300 with detailed exemplary method steps for update of offline parameter(s). The exemplary method depicted in FIG. 3 could be implemented, for example, by an application running on a terminal such as one of the readers 124, 126. After starting at step 302, a first transaction (the aforementioned online transaction) can be conducted with the online-capable application, as shown at step 304, and a value of the offline parameter can be read as at step 306. In one sense, steps 304, 306 can be thought of as corresponding to the detecting step 204 of FIG. 2. A second transaction (such as offline balance top up) can be conducted, as at 310, with the primarily offline application to update the value of the offline parameter, if the offline parameter requires updating, as determined in decision block 308. Step 310 can be thought of as corresponding to the updating step 206 of FIG. 2. At block 312, after the update, one can continue with additional transactions or updates as required or desired. It will be appreciated that the method just described can be performed as one possible detailed implementation of the method of FIG. 2. Note that, as with FIG. 2, more than one offline parameter can be updated in the methods described and illustrated with respect to FIGS. 3 and 4, and elsewhere herein.

The primarily offline application could be, for example, a primarily offline payment application having an offline balance. The notation “primarily offline” is employed, since the application is intended for offline use, e.g., to make purchases without communicating with an issuer's host computer. However, to update offline parameters, such as adding value to the offline application, the offline application will typically effectively be able to “go online” for that purpose. The offline parameter can, in general, be a risk management parameter pertaining to the offline balance. By way of example and not limitation, a first type of offline parameter could include a cumulative offline transaction amount (COTA). Another type of offline parameter could include an upper allowable limit of COTA (UCOTA). The remaining offline balance available for spending would then be UCOTA-COTA. So, for example, if $50 were applied to the offline application, before any transactions occurred, UCOTA would be $50 and COTA would be $0. After, say, a $10 purchase, UCOTA would be $50 and COTA would be $10, leaving $40 available to spend. After an additional $5 purchase, UCOTA would still be $50 and COTA would be $15, leaving an offline balance of $35 available to spend. Thus, in one exemplary embodiment, updating the offline parameter could involve debiting a card holder's account for the amount of COTA and re-setting COTA to zero, thus topping up the offline balance by making the full amount of UCOTA again available to spend. Of course, other schemes are possible, for example, COTA could simply be allowed to run up, and UCOTA could be raised sufficiently to allow an offline spending limit as desired. Further, more than one offline parameter could be changed, for example, COTA could be re-set to zero and UCOTA could be raised, to allow a responsible card holder a greater offline spending balance.

Another type of offline parameter could include a maximum allowable offline transaction amount, for example, for purposes of enhancing security. In this regard, note that various schemes can be employed to protect card holders, merchants, and/or card issuers. For example, funds in a financial account linked to the offline spending application can be earmarked for offline expenditures, or overdraft-style protection can be provided. Since offline spending is conducted without communication with the card issuer, there may be more risk than with online transactions, and in general, offline spending may be used for smaller transactions (although the principles of the present invention can be applied in any case).

The online-capable application could be a debit payment application, a credit payment application, or could incorporate elements of both. Different security levels could be employed for different functions pertaining to the primarily offline application, depending on whether an offline transaction or a top up was being conducted. For example, offline transactions could be conducted, in essence, like a cash equivalent, with no PIN protection, or PIN entry could be required. Top up, since it involves access to the remote host, could be conducted at a higher security level, using at least PIN protection, and additional protections if desired. Other security options and related options can include disabling the IC chips of lost or stolen cards, providing for cancellation of vending machine transactions when product is not delivered, and the like.

FIG. 4 shows a flow chart 400 with exemplary detailed method steps for another possible method of updating offline parameter(s). The exemplary method depicted in FIG. 4 could itself be implemented, for example, by an application running on a payment device such as one of the cards 102, 112. After starting at step 402, one could detect, via the online-capable application, status of the primarily offline application, as shown at step 404. Step 404 can be thought of as corresponding to the detecting step 204 of FIG. 2. As shown at block 408, as step of establishing on-line communication, via the online-capable application, can be performed. Such establishment could be responsive to detection of the status of the primarily offline application as requiring the offline parameter to be updated, at decision block 406. The method could further include obtaining, via the online-capable application, an update to the offline parameter of the primarily offline application, as at step 410. The steps just described can be thought of as corresponding to the updating step 206 of FIG. 2. At block 412, after the update, one can continue with additional transactions or updates as required or desired. The above comments, following the description of FIG. 3, regarding the nature of the offline parameter(s), the primarily offline and online-capable applications, security levels, and the like apply to FIG. 4 as well.

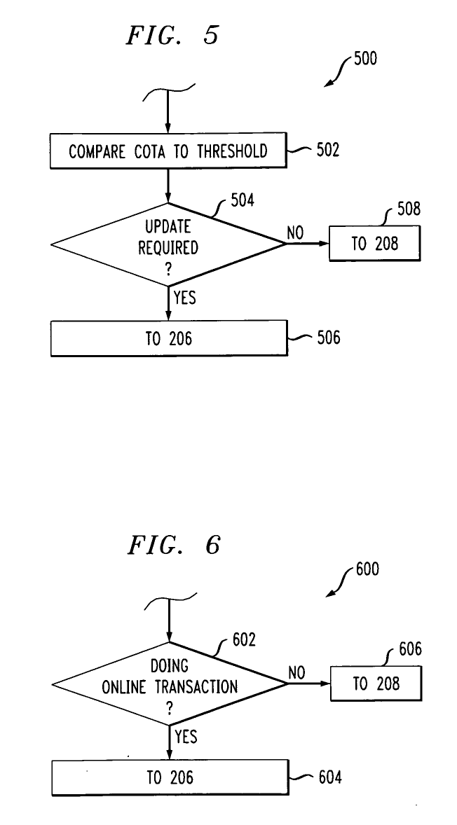

It should be noted that the ordering of the method steps depicted herein, including those in FIG. 4, is intended to be illustrative in nature, and other orderings are possible. For example, the primarily online application could decide to go online for its own purposes, and the test to see whether an update to the offline parameter was required could be conducted after online communication was established. Thus, steps 406 and 408 could be reversed in order. Furthermore, decision block 406 could be part of an equivalent decision in the online application, which the online application would take into account when deciding to go online. Fundamentally, one can determine whether either application needs to go online, and if not, one can work offline; if the online application needs to go online, one can go online (see discussion of FIG. 6 below), but even if not required by the online application, if the offline application needs updating (e.g., because the balance is too low—see discussion of FIG. 5 below), one can still go online. This provides benefits as compared to the prior art Binder et al. publication, since online updating need not await a conscious decision by the card holder, or an unsuccessful offline transaction (an unsuccessful or failed offline transaction can refer to a transaction that cannot be conducted offline and so must be completed online, as well as a transaction that cannot be completed at all).

It will thus be appreciated that FIGS. 3 and 4 depict, in one sense, possible alternative implementations of the basic method of FIG. 2, and that each provides a different way of achieving the same desired result. Using the techniques of FIG. 3, a terminal can make required decisions by examining the offline parameter when going online for an online transaction; if an update to the offline parameter is required, a second transaction (e.g., top up) can be made to update the offline parameter. This approach may be advantageous where it is desired to use techniques of the present invention with previously-existing payment devices with multiple applications, without having to substantially change such devices already in the hands of card holders. However, techniques of FIG. 3 may result in increased transaction times, due to the need for a second transaction when a top up is required. Using the techniques of FIG. 4, the debit and/or credit card application on the payment device makes the determination whether it is necessary to go online. Here, top up is effected by obtaining the update to the offline parameter via the online-capable application. This approach is believed preferable to that of FIG. 3, allowing for a faster total transaction time, but may have the disadvantage of requiring substantial modification or replacement of existing payment cards (conversely, a possible advantage is reducing or eliminating the need for any modification to terminal applications). A combination of both techniques can be employed, if desired (for example, one could use the techniques of FIG. 3 to implement a terminal-side approach at locations such as ATMs until new cards incorporating techniques of FIG. 4 could be distributed). Techniques of the present invention can thus render possible an offline spending device with limited need for the card holder to be concerned about the offline balance, where a debit or credit card experience can be substantially replicated.

FIG. 5 shows a flow chart 500 of certain optional method steps useful in connection with the method of FIG. 2. More specifically, FIG. 5 represents decisional logic in a case where one aspect of the decision to go online is whether the offline parameter requires updating. Here, by way of example, the offline parameter is COTA. At step 502, COTA is compared to a threshold such as UCOTA; if too close (meaning too little offline balance remaining), decision block 504 will determine that an update is required, and processing will flow, as indicated at step 506, to block 206 of FIG. 2. Conversely, if no update is required at present, as per step 508, flow is routed to block 208 of FIG. 2. Of course, the foregoing description is merely illustrative, and there are other ways that offline parameters can be set up to control offline spending and provide top up of an offline balance.

FIG. 6 shows a flow chart 600 of certain other optional method steps useful in connection with the method of FIG. 2. More specifically, FIG. 6 represents decisional logic in a case where one aspect of the decision to go online is simply whether the online-capable application is going online in any case. Here, by way of example, the offline parameter could also be COTA. At decision block 602, if it is determined that an online transaction is to occur in any case, processing will flow, as indicated at step 604, to block 206 of FIG. 2. Conversely, if no online transaction is to be conducted at present, as per step 606, flow is routed to block 208 of FIG. 2. It is to be appreciated that FIGS. 5 and 6 are not mutually exclusive, and both types of logic can be used together to decide if the offline parameter should be updated online.

Additional exemplary details will now be presented regarding inventive payment apparatuses, such as cards 102, 112. Turning first to FIG. 7, in one aspect of the invention, a payment device 700 employs a shared offline parameter (e.g., a counter such as COTA) with a single firmware implementation, two data sets, and two AIDs. Thus, the online-capable application 702 can include a first application identifier 708, a shared firmware implementation 710, and an online data set 706. The primarily offline application 704 can include a second application identifier 714, the shared firmware implementation 710, and an offline data set 712. Data indicative of a value of the offline parameter (preferably simply the value of COTA) is shared by the online-capable application 702 and the primarily offline application 704.

In another aspect, as shown in FIG. 8, two separate counters are employed but the online-capable application can “see” the offline counter. The payment apparatus 800 includes online-capable application 802 having a first application identifier 810, an online-capable application firmware implementation 812, an online counter 808, and an online data set 806. The primarily offline application 804 includes a second application identifier 818, a primarily offline application firmware implementation 820, an offline counter 816, and an offline data set 814. The offline counter can include data indicative of a value of the offline parameter, and the offline counter 816 can be visible to the online-capable application 802, as suggested by the interconnecting dotted line. Again, for example, the offline parameter can simply be an offline counter such as COTA.

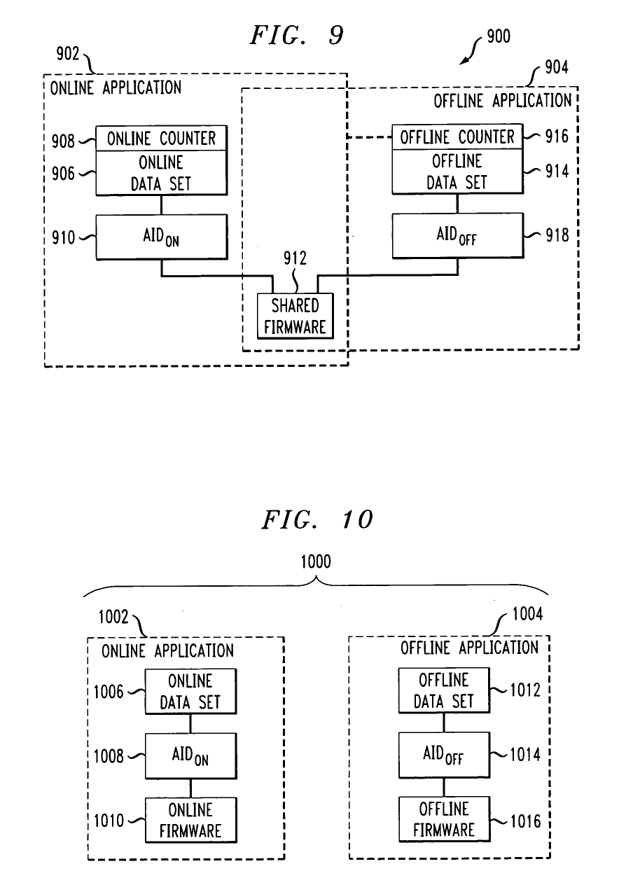

In yet another aspect, as shown in FIG. 9, two separate counters can be employed, the online-capable application can see the offline counter, and shared firmware is utilized. Thus, the payment apparatus 900 includes online-capable application 902 with a first application identifier 910, a shared firmware implementation 912, an online counter 908, and an online data set 906. The primarily offline application 904 can include a second application identifier 918, the shared firmware implementation 912, an offline counter 916, and an offline data set 914. The offline counter 916 can include data indicative of a value of the offline parameter, and can be visible to the online-capable application 902, as suggested by the interconnecting dotted line. The counters 908, 916 and the data sets 906, 914 can be implemented in different memory spaces (e.g., one for the online-capable application and one for the primarily offline application) or in a shared memory space. In the latter case, one could visualize the counters 908, 916 and the data sets 906, 914 as residing within the region where the dotted boxes 902, 904 intersect (with shared firmware 912).

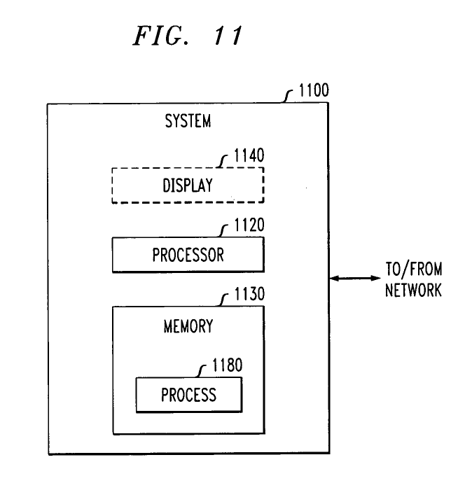

In still another aspect, as shown in FIG. 10, a shared offline counter, without shared firmware, can be employed. The payment apparatus 1000 can include the online-capable application 1002, with a first application identifier 1008, an online-capable application firmware implementation 1010, and an online data set 1006. The primarily offline application 1004 can include a second application identifier 1014, a primarily offline application firmware implementation 1016, and an offline data set 1012. Data indicative of a value of the offline parameter is shared by the online-capable application 1002 and the primarily offline application 1004.

The invention can employ hardware and/or software aspects. Software includes but is not limited to firmware, resident software, microcode, etc. Software might be employed, for example, in connection with a reader 122, 124, 126, 134, 136. Firmware might be employed, for example, in connection with payment devices such as cards 102, 112. FIG. 11 is a block diagram of a system 1100 that can implement part or all of one or more aspects or processes of the present invention. As shown in FIG. 11, memory 1130 configures the processor 1120 (which could correspond, e.g., to processor portions 106, 116) to implement one or more aspects of the methods, steps, and functions disclosed herein (collectively, shown as process 1180 in FIG. 11). The memory 1130 could be distributed or local and the processor 1120 could be distributed or singular. The memory 1130 could be implemented as an electrical, magnetic or optical memory, or any combination of these or other types of storage devices (including memory portions as described above with respect to cards 102, 112). It should be noted that if distributed processors are employed, each distributed processor that makes up processor 1120 generally contains its own addressable memory space. It should also be noted that some or all of computer system 1100 can be incorporated into an application-specific or general-use integrated circuit. For example, one or more method steps could be implemented in hardware in an ASIC rather than using firmware. Display 1140 is representative of a variety of possible input/output devices; cards might typically not have such displays, but terminals, readers, PDAs and the like might have such displays.

System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned readers 122, 124, 126, 134, 136 or payment devices such as cards 102, 112 can make use of computer technology with appropriate instructions to implement method steps described herein. By way of further example, a reader apparatus 122, 124, 126, 134, 136 could include a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A computer-implemented method of updating an offline parameter of a payment device having an online-capable application and a primarily offline application, said offline parameter being a parameter of said primarily offline application, said method comprising the steps of:
detecting a requirement to update said offline parameter; and
updating said offline parameter substantially contemporaneously with a separate online transaction.

2. The computer-implemented method of claim 1, wherein:
said detecting step comprises:
conducting a first transaction with said online-capable application, said first transaction being said online transaction; and
reading a value of said offline parameter; and
said updating step comprises:
conducting a second transaction with said primarily offline application to update said value of said offline parameter, if said offline parameter requires updating.

3. The computer-implemented method of claim 2, wherein said primarily offline application is a primarily offline payment application having an offline balance.

4. The computer-implemented method of claim 3, wherein:
said online-capable application is at least one of a debit payment application and a credit payment application;
said primarily offline payment application is configured for offline transactions at a first security level and for top-up at a second security level;
said offline parameter is a risk management parameter pertaining to said offline balance; and
said top-up comprises said second transaction.

5. The computer-implemented method of claim 1, wherein:
said detecting step comprises detecting, via said online-capable application, status of said primarily offline application; and
said updating step comprises:
responsive to detection of said status of said primarily offline application as requiring said offline parameter to be updated, establishing on-line communication, via said online-capable application; and
obtaining, via said online-capable application, an update to said offline parameter of said primarily offline application.

6. The computer-implemented method of claim 5, wherein said primarily offline application is a primarily offline payment application having an offline balance.

7. The computer-implemented method of claim 6, wherein:
said online-capable application is at least one of a debit payment application and a credit payment application;
said primarily offline payment application is configured for offline transactions at a first security level and for top-up at a second security level;
said offline parameter is a risk management parameter pertaining to said offline balance; and
said top-up comprises said obtaining of said update to said offline parameter via said online-capable application.

8. The computer-implemented method of claim 1, wherein said offline parameter comprises a cumulative offline transaction amount and said detecting step comprises comparing said cumulative offline transaction amount to a threshold value.

9. The computer-implemented method of claim 1, wherein said offline parameter comprises a cumulative offline transaction amount and said detecting step comprises determining whether said online transaction is to be performed.

10. The computer-implemented method of claim 1, wherein said updating step further comprises updating a second offline parameter of said primarily offline application.

11. A payment apparatus comprising:
a body portion;
a memory associated with said body portion, said memory containing:
an online-capable application; and
a primarily offline application having an offline parameter; and
at least one processor associated with said body portion and coupled to said memory, said processor being operative to:
detect a requirement to update said offline parameter; and
update said offline parameter substantially contemporaneously with an online transaction.

12. The payment apparatus of claim 11, wherein said processor is further operative to:
detect said requirement to update said offline parameter by:
detecting, via said online-capable application, status of said primarily offline application; and
update said offline parameter substantially contemporaneously with said online transaction by:
responsive to detection of said status of said primarily offline application as requiring said offline parameter to be updated, establishing on-line communication, via said online-capable application; and
obtaining, via said online-capable application, an update to said offline parameter of said primarily offline application.

13. The payment apparatus of claim 12, wherein said primarily offline application is a primarily offline payment application having an offline balance.

14. The payment apparatus of claim 13, wherein:
said online-capable application is at least one of a debit payment application and a credit payment application;
said primarily offline payment application is configured for offline transactions at a first security level and for top-up at a second security level;
said offline parameter is a risk management parameter pertaining to said offline balance; and
said top-up comprises said processor obtaining said update to said offline parameter via said online-capable application.

15. The payment apparatus of claim 11, wherein:
said online-capable application comprises a first application identifier, a shared firmware implementation, and an online data set;
said primarily offline application comprises a second application identifier, said shared firmware implementation, and an offline data set; and
data indicative of a value of said offline parameter is shared by said online-capable application and said primarily offline application.

16. The payment apparatus of claim 11, wherein:
said online-capable application comprises a first application identifier, an online-capable application firmware implementation, an online counter, and an online data set;
said primarily offline application comprises a second application identifier, a primarily offline application firmware implementation, an offline counter, and an offline data set; and
said offline counter comprises data indicative of a value of said offline parameter, said offline counter being visible to said online-capable application.

17. The payment apparatus of claim 11, wherein:
said online-capable application comprises a first application identifier, an online-capable application firmware implementation, and an online data set;
said primarily offline application comprises a second application identifier, a primarily offline application firmware implementation, and an offline data set; and
data indicative of a value of said offline parameter is shared by said online-capable application and said primarily offline application.

18. The payment apparatus of claim 11, wherein:
said online-capable application comprises a first application identifier, a shared firmware implementation, an online counter, and an online data set;
said primarily offline application comprises a second application identifier, said shared firmware implementation, an offline counter, and an offline data set; and
said offline counter comprises data indicative of a value of said offline parameter, said offline counter being visible to said online-capable application.

19. The payment apparatus of claim 18, wherein:
said online counter and said online data set reside in a first memory space; and
said offline counter and said offline data set reside in a second memory space.

20. The payment apparatus of claim 18, wherein said online counter, said online data set, said offline counter, and said offline data set reside in a shared memory space.

21. A terminal apparatus for interacting with a payment device having an online-capable application and a primarily offline application with an offline parameter, said terminal apparatus comprising:
a reader module;
a memory associated with said reader module; and
at least one processor coupled to said memory, said processor being operative to:
detect a requirement to update said offline parameter; and
update said offline parameter substantially contemporaneously with a separate online transaction.

22. The terminal apparatus of claim 21, wherein said processor is further operative to:
detect said requirement to update said offline parameter by:
conducting a first transaction with said online-capable application, said first transaction being said online transaction; and
reading a value of said offline parameter; and
update said offline parameter substantially contemporaneously with said online transaction by:
conducting a second transaction with said primarily offline application to update said value of said offline parameter, if said offline parameter requires updating.

23. An article of manufacture for updating an offline parameter of a payment device having an online-capable application and a primarily offline application, said offline parameter being a parameter of said primarily offline application, said article of manufacture comprising a machine readable medium containing one or more programs which when executed implement the steps of:
detecting a requirement to update said offline parameter; and
updating said offline parameter substantially contemporaneously with a separate online transaction.

24. The article of manufacture of claim 23, wherein:
said detecting step comprises:
conducting a first transaction with said online-capable application, said first transaction being said online transaction; and
reading a value of said offline parameter; and
said updating step comprises:
conducting a second transaction with said primarily offline application to update said value of said offline parameter, if said offline parameter requires updating.

25. The article of manufacture of claim 23, wherein:
said detecting step comprises detecting, via said online-capable application, status of said primarily offline application; and
said updating step comprises:
responsive to detection of said status of said primarily offline application as requiring said offline parameter to be updated, establishing on-line communication, via said online-capable application; and
obtaining, via said online-capable application, an update to said offline parameter of said primarily offline application.
